(19) United States
(12) Patent Application Publication
(10) Pub. No.: US 2026/0368277 A1
(43) Pub. Date: Nov. 19, 2026

(54) DATA CORRECTION USING REPRESENTATIVE SUB-SPACE COMPARISONS

(71) Applicant: International Business Machines Corporation, Armonk, NY (US)

(72) Inventors: Burkhard Ringlein, Bülach (CH); Srikumar Venugopal, Dublin (IE); Michael Johnston, Dublin (IE); Christoph Hagleitner, Wallisellen (CH); Christian Pinto, Dublin (IE); Alessandro Pomponio, Dublin (IE); Vasileios Vasileiadis, Dublin (IE)

(21) Appl. No.: 19/208,368

(22) Filed: May 14, 2025

(51) Int. Cl. G06F 18/22; G06F 18/2113; G06F 18/213; G06F 18/2321

(52) U.S. Cl. CPC G06F 18/22; G06F 18/2113; G06F 18/213; G06F 18/2321

(57) ABSTRACT

A method, according to one approach, includes: identifying representative configurations in a source set of measured configurations. Counterparts of the representative configurations are determined in a target set of unmeasured configurations. Moreover, performance metrics for the counterparts in the target set are evaluated and similarities between the source and target sets are assessed. Furthermore, a determination is made as to whether the measurements in the source set can be applied to the target set.

### BACKGROUND

The present invention relates to data analysis, and more specifically, this invention relates to comparing configurations.

The complexity of compute systems has been steadily increasing over time. This has been driven by rapid advancements in hardware architecture, software frameworks, and the ever-growing demand for performance. As an example, the transition from single-core processors to multi-core and more complex architectures involving GPUs, TPUs, FPGAs, and specialized accelerators, have caused systems themselves to become significantly more intricate. These platforms are further complicated by layers of abstraction that stem from virtualization, containerization, orchestration, etc., systems.

With each leap in compute capability comes a corresponding rise in the number of variables and interactions therebetween that must be understood and accounted for in order to effectively operate a given system. It follows that exploring the parameter space exhaustively is prohibitive in both time and space for conventional systems.

A method, according to one approach, includes: identifying representative configurations in a source set of measured configurations. Counterparts of the representative configurations are determined in a target set of unmeasured configurations. Moreover, performance metrics for the counterparts in the target set are evaluated and similarities between the source and target sets are assessed. Furthermore, a determination is made as to whether the measurements in the source set can be applied to the target set.

A computer program product, according to another approach, includes: one or more computer-readable storage media. The computer program product further includes program instructions that are stored on the one or more storage media to perform the foregoing method.

A computer system, according to yet another approach, includes: a processor set, and one or more computer-readable storage media. The computer system also includes program instructions that are stored on the one or more storage media to cause the processor set to perform the foregoing method.

Other aspects and implementations of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one approach.

FIG. 2A is a representational view of a distributed system, in accordance with one approach.

FIG. 2B is a partial detailed overview of logical and/or physical components, in accordance with one approach.

FIG. 3A is a flowchart of a method, in accordance with one approach.

FIG. 3B is a flowchart of steps for one or more of the operations in the method of FIG. 3A, in accordance with one approach.

FIG. 4 is a flowchart of how a measured source set of configurations may be compared against a set of unmeasured configurations, in accordance with an in-use example.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms "a," "an" and "the" include plural referents unless otherwise specified. It will be further understood that the terms "comprises" and/or "comprising," when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods and computer program products for predicting the performance metrics of a target set of unmeasured configurations using a source set of measured configurations. Approaches herein may thereby be used to determine a configuration for a specific application that meets predetermined performance objective(s) without experiencing performance shortcomings like conventional products. Again, approaches herein utilize the performance values from measured sets of configurations as a proxy for performance values for an unmeasured set of configurations. Approaches herein thereby involve identifying a most desirable (e.g., “best”) configuration while also keeping search costs within reasonable bounds. This desirably avoids the cost of benchmarking the entirety of an unknown target set. Approaches herein thereby have a significant impact on efficiency of the system overall, e.g., as will be described in further detail below.

In one general approach, a method includes: identifying representative configurations in a source set of measured configurations. Counterparts of the representative configurations are determined in a target set of unmeasured configurations. Moreover, performance metrics for the counterparts in the target set are evaluated and similarities between the source and target sets are assessed. Furthermore, a determination is made as to whether the measurements in the source set can be applied to the target set.

In another general approach, a computer program product includes: one or more computer-readable storage media. The computer program product further includes program instructions that are stored on the one or more storage media to perform the foregoing method.

In yet another general approach, a computer system includes: a processor set, and one or more computer-readable storage media. The computer system also includes program instructions that are stored on the one or more storage media to cause the processor set to perform the foregoing method.

Various aspects of the present disclosure are described by narrative text, flowcharts, block diagrams of computer systems and/or block diagrams of the machine logic included in computer program product (CPP) approaches. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner that is at least partially overlapping in time.

A computer program product approach ("CPP approach" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as improved configuration code in block 150 for predicting the performance metrics of a target set of unmeasured configurations using a source set of measured configurations. Approaches herein may thereby be used to determine a configuration for a specific application that meets predetermined performance objective(s) without experiencing performance shortcomings like conventional products. Again, approaches herein utilize the performance values from measured sets of configurations as a proxy for performance values for an unmeasured set of configurations. Approaches herein thereby involve identifying a most desirable (e.g., “best”) configuration while also keeping search costs within reasonable bounds. This desirably avoids the cost of benchmarking the entirety of an unknown target set. Approaches herein thereby have a significant impact on efficiency of the system overall, e.g., as will be described in further detail below.

In addition to block 150, computing environment 100 includes, for example, computer 101, wide area network (WAN) 102, end user device (EUD) 103, remote server 104, public cloud 105, and private cloud 106. In this approach, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

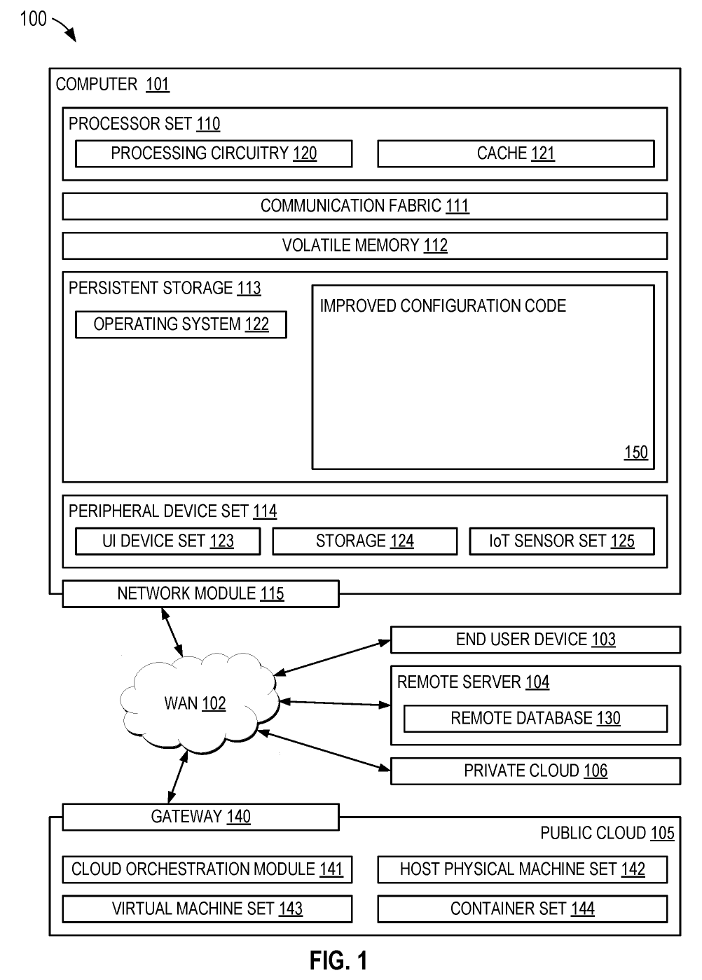

COMPUTER 101 may take the form of a desktop computer, laptop computer, tablet computer, smart phone, smart watch or other wearable computer, mainframe computer, quantum computer or any other form of computer or mobile device now known or to be capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various approaches, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some approaches, storage 124 may take the form of a quantum computing storage device for storing data in the form of qubits. In approaches where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some approaches, network control functions and network forwarding functions of network module 115 are performed on the same physical hardware device. In other approaches (for example, approaches that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some approaches, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some approaches, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other approaches a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this approach, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some approaches, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various approaches may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By “integrated with,” what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various approaches.

As noted above, the complexity of compute systems has been steadily increasing over time. This has been driven by rapid advancements in hardware architecture, software frameworks, and the ever-growing demand for performance. As an example, the transition from single-core processors to multi-core and more complex architectures involving GPUs, TPUs, FPGAs, and specialized accelerators, have caused systems themselves to become significantly more intricate. These platforms are further complicated by layers of abstraction that stem from virtualization, containerization, orchestration, etc., systems.

With each leap in compute capability comes a corresponding rise in the number of variables and interactions therebetween that must be understood and accounted for in order to effectively operate a given system. According to non-limiting example, a conventional big data analytics application may include 51,840 different possible configurations. Accounting for about 2 hours of testing/evaluation per configuration, it would take conventional systems approximately 11 years to perform an exhaustive search across all possibilities. In another non-limiting example, a large language model application may have 5,598,720 different possible configurations. In this example, even spending 15 minutes evaluating each of the different configurations would cause an exhaustive search to take approximately 128 years. It follows that exploring the parameter space exhaustively is prohibitive in both time and space for conventional systems.

This escalating complexity makes accurate modeling of compute systems a much more challenging task. Conventional systems have thereby been unable to accurately capture nuanced behaviors across hardware and software layers, understand dynamic workloads, and adapt to unpredictable resource contention and latency patterns. This has in turn caused traditional modeling techniques to experience performance setbacks. Furthermore, as compute systems become more modular, interconnected, and intelligent, the process of modeling them shifts from a static, one-time design activity to an ongoing, iterative process that involves deeper domain knowledge.

In sharp contrast, approaches herein are able to determine the configuration for a specific application that meets predetermined performance objective(s) without experiencing the foregoing conventional shortcomings. Again, while conventional implementations are enormously time-consuming by evaluating every possible configuration, approaches herein utilize the performance values from measured sets of configurations (e.g., a “source”) as a proxy for performance values for an unmeasured set of configurations (e.g., a “target”). This may be accomplished in some approaches by selecting a subset of the source, identifying counterparts for this set of representative configurations in the target space, and comparing the performance values across both subsets. In situations where the subsets are considered statistically similar, the source set may be used to answer all questions about the target configuration set. This desirably avoids the cost of benchmarking the entirety of the target set.

As used herein, a “configuration” includes a set of parameters and values that determine the behaviour and performance of a given implementation. It follows that a “configuration search” as used herein refers to the process of identifying a desirable (e.g., optimal) resource and application configuration that meets defined Service-Level-Agreements (SLAs) and/or Budgets for a given target workload deployment. In particular, approaches herein may be tailored to focus on very large search spaces with millions of potential configurations that may be solutions to various situations, e.g., as would be appreciated by one skilled in the art after reading the present description.

Approaches herein thereby involve identifying a most desirable (e.g., “best”) configuration while also keeping search costs within reasonable bounds. For example, a relaxed criteria may be implemented to identify one or more configuration(s) that are able to operate or perform in a best given percentage (e.g. 2%). Approaches herein that search and identify configurations that are determined to perform at desirable levels involves defining a configuration space and an action space where benchmarks are executed on different configurations. As noted above, conventional search spaces tend to become very large (e.g., more than 1 million data points, constrained to less than about $1,000 worth of compute time), but infrastructure and applications change frequently. For example, it is common for only minor changes (e.g. software update, infrastructure update (CPU/RAM/GPU), new feature for corner case, etc.) having minimal impact to be experienced. Keeping search costs low thereby calls for knowing if and/or why data that was collected before a minor change can still be used and “trusted” by the system. The approaches herein thereby have a significant impact on efficiency of the system overall, e.g., as will be described in further detail below.

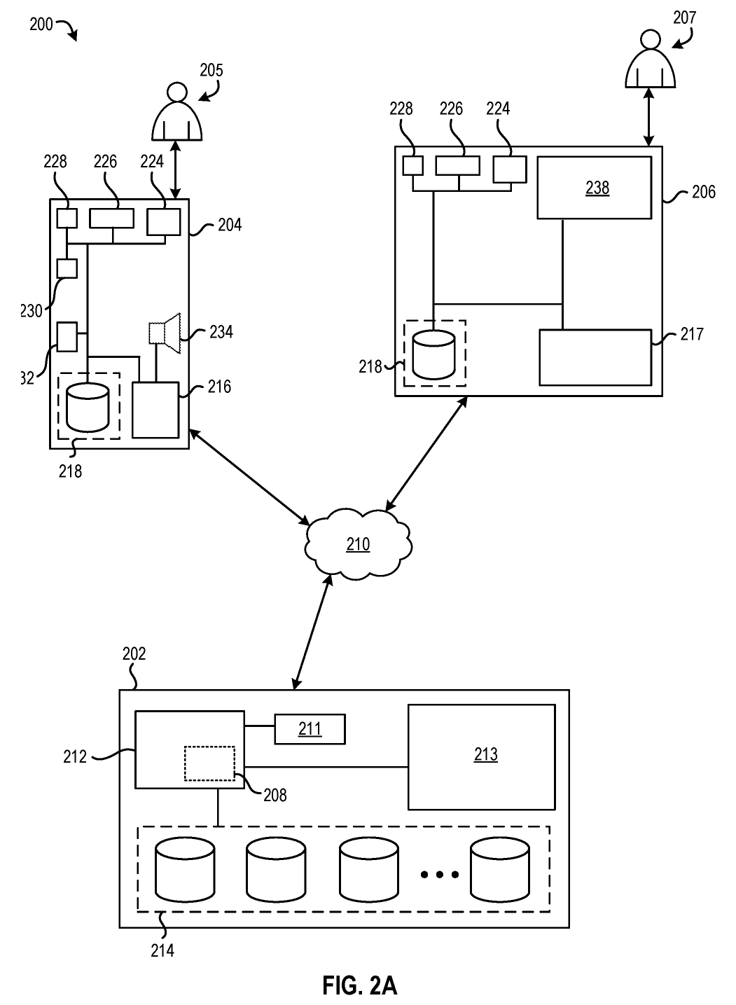

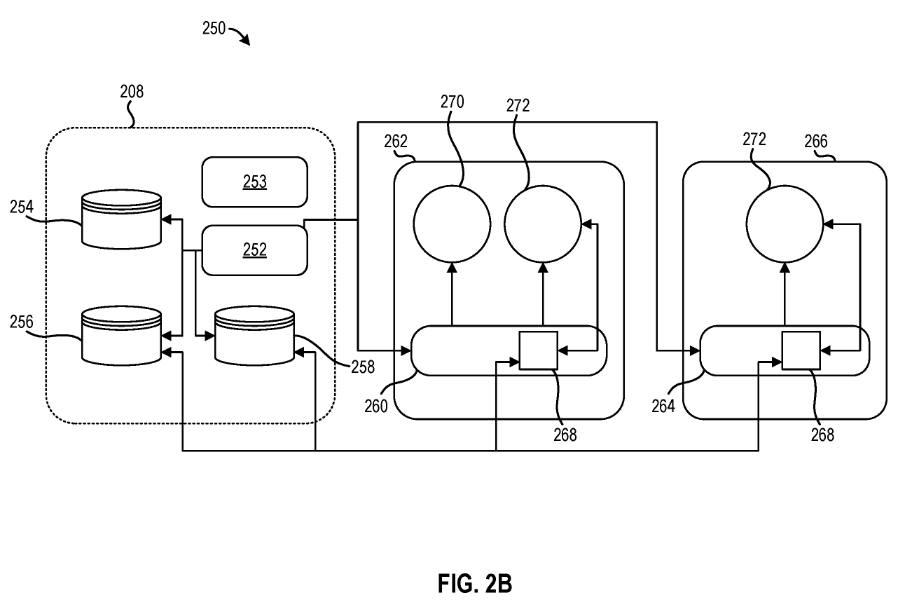

Looking now to FIG. 2A, a system 200 having a distributed architecture is illustrated in accordance with one approach. As an option, the present system 200 may be implemented in conjunction with features from any other approach listed herein, such as those described with reference to the other FIGS., such as FIG. 1. However, such system 200 and others presented herein may be used in various applications and/or in permutations which may or may not be specifically described in the illustrative approaches or implementations listed herein. Further, the system 200 presented herein may be used in any desired environment. Thus FIG. 2A (and the other FIGS.) may be deemed to include any possible permutation.

As shown, the system 200 includes a central server 202 that is connected to a user device 204, and edge node 206 accessible to the user 205 and administrator 207, respectively. The central server 202, user device 204, and edge node 206 are each connected to a network 210, and may thereby be positioned in different geographical locations. The network 210 may be of any type, e.g., depending on the desired approach. For instance, in some approaches the network 210 is a WAN, e.g., such as the Internet. However, an illustrative list of other network types which network 210 may implement includes, but is not limited to, a LAN, a PSTN, a SAN, an internal telephone network, etc. As a result, any desired information, data, commands, instructions, responses, requests, etc. may be sent between user device 204, edge node 206, and/or central server 202, regardless of the amount of separation which exists therebetween, e.g., despite being positioned at different geographical locations.

However, it should be noted that two or more of the user device 204, edge node 206, and central server 202 may be connected differently depending on the approach. According to an example, which is in no way intended to limit the invention, two servers (e.g., nodes) may be located relatively close to each other and connected by a wired connection, e.g., a cable, a fiber-optic link, a wire, etc.; etc., or any other type of connection which would be apparent to one skilled in the art after reading the present description.

The terms “user” and “administrator” are in no way intended to be limiting either. For instance, while users and clients may be described as being individuals in various implementations herein, a user and/or client may be an application, an organization, a preset process, etc. The use of “data” and “information” herein is in no way intended to be limiting either, and may include any desired type of details, e.g., depending on the type of operating system implemented on the user device 204, edge node 206, and/or central server 202. For example, video data, audio data, sensor data, metadata, outputs produced by AI based models, images, etc. may be sent to the central server 202 from user device 204 and/or edge node 206 for processing using one or more AI based models, e.g., such as a foundation model and/or machine learning models.

With continued reference to FIG. 2A, the central server 202 includes a large (e.g., robust) processor 212 coupled to a cache 211, an AI module 213, and a data storage array 214 having a relatively high storage capacity. As noted above, the AI module 213 may include any desired number and/or type of AI based models (e.g., machine learning models). In preferred approaches, the AI module 213 and/or processor 212 includes one or more AI based models that have been trained to analyze a plurality of different system configurations in a thorough and efficient manner. For instance, while conventional implementations are enormously time-consuming by evaluating every possible configuration, approaches herein utilize the performance values from measured sets of configurations (e.g., a “source”) as a proxy for performance values for an unmeasured set of configurations (e.g., a “target”). This may be accomplished in some approaches by using the trained AI based models to evaluate a source set of measured configurations, identify counterparts for this source set of representative configurations in an unmeasured target set, and comparing the performance values across both sets. In situations where the subsets are considered statistically similar, the source set may be used to answer all questions about the target configuration set.

This desirably avoids the cost of benchmarking the entirety of the target set. As noted above, analyzing large numbers of configurations, particularly unmeasured configurations, is a difficult and taxing process, even in situations where specialized tools are available. As a result, conventional products have been unable to provide reliable analysis. In contrast, machine learning module 213 and/or processor 212 may be able to analyze unmeasured configurations and determine information from measured sets of configurations which can be used to process the unmeasured configurations in a most efficient manner.

Depending on the approach, the AI based models used herein may include one or more regression models that can be applied to solve a problem. For example, linear, support vector regression, decision tree regression, etc. may be generated and trained to evaluate data and determine a most desirable configuration which causes a corresponding system and/or application to operate in a most efficient manner. For example, neural networks are able to model non-linear relationships between inputs and outputs. This means that neural networks can capture more complex patterns and relationships in data, which can lead to better predictions and classifications of different configurations. Additionally, neural networks can be trained on large amounts of data, which can improve their accuracy and performance.

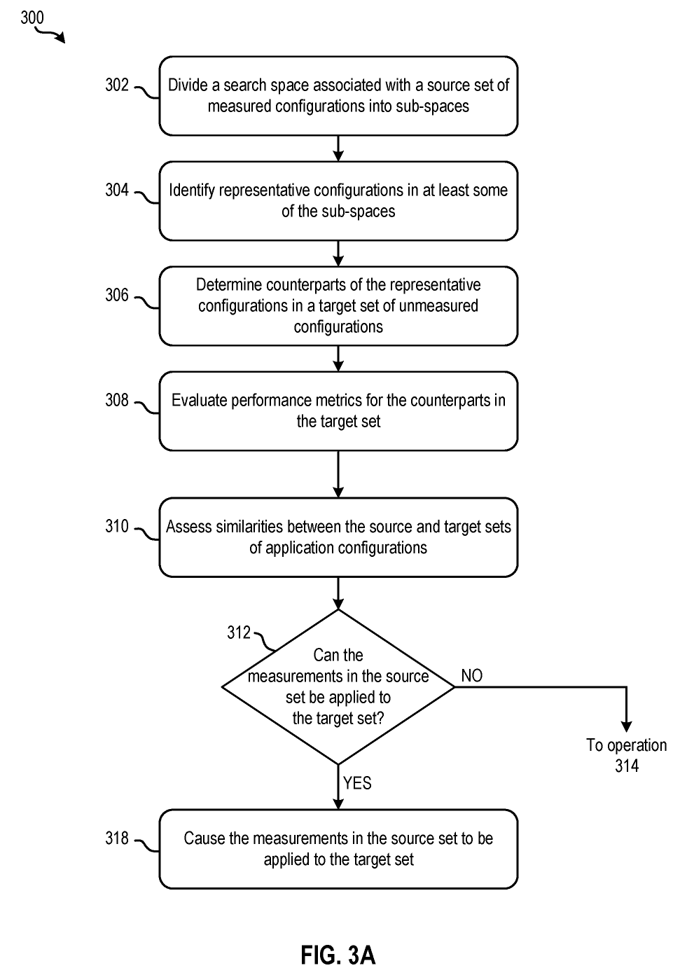

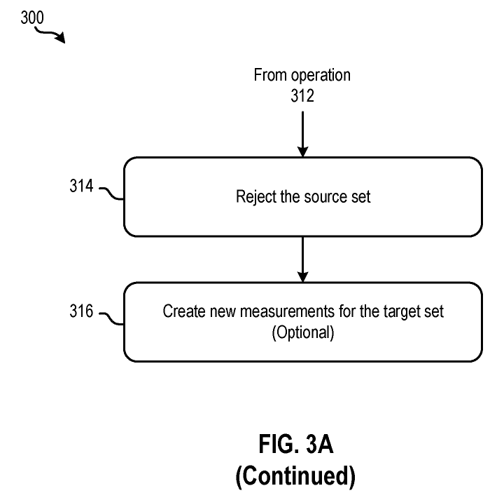

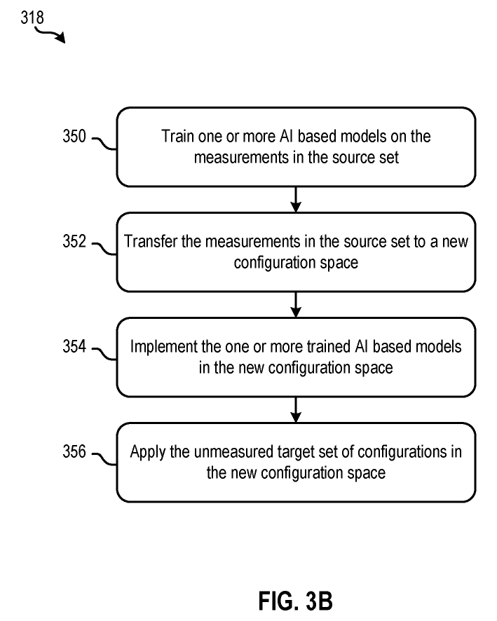

The processor 212 is also shown as including a control plane 208 configured to evaluate and manage the life-cycle of discovery spaces, operations performed on the discovery spaces, and other resources that are related thereto. In other words, the control plane 208 is able to inspect previously measured configurations and determine whether any of the measured configuration sets overlap unmeasured configurations. It follows that in some approaches, control plane 208 may be used in combination with performing one or more of the operations included in method 300 of FIG. 3A below.

With continued reference to FIG. 2A, user device 204 includes a processor 216 coupled to memory 218 and receives inputs from and interfaces with user 205. For instance, the user 205 may input information using one or more of: a display screen 224, keys of a computer keyboard 226, a computer mouse 228, a microphone 230, and a camera 232. The processor 216 may thereby be configured to receive inputs (e.g., text, sounds, images, motion data, etc.) from any of these components as entered by the user 205. These inputs typically correspond to information presented on the display screen 224 while the entries were received. Moreover, the inputs received from the keyboard 226 and computer mouse 228 may impact the information shown on display screen 224, data stored in memory 218, information collected from the microphone 230 and/or camera 232, status of an operating system being implemented by processor 216, etc. The electronic device 204 also includes a speaker 234 which may be used to play (e.g., project) audio signals for the user 205 to hear.

Looking to the edge node 206, some of the components included therein may be the same or similar to those included in user device 204, some of which have been given corresponding numbering. For instance, processor 217 is coupled to memory 218, a display screen 224, keys of a computer keyboard 226, and a computer mouse 228. Additionally, the processor 217 is coupled to a machine learning module 238. As described above with respect to machine learning module 213, the machine learning module 238 may include any desired number and/or type of AI based models. In preferred approaches, the machine learning module 238 includes AI based models that have been trained to analyze a plurality of different system configurations in a thorough and efficient manner. This may be accomplished in some approaches by using the trained AI based models to evaluate a source set of measured configurations, identify counterparts for this source set of representative configurations in an unmeasured target set, and comparing the performance values across both sets. In situations where the subsets are considered statistically similar, the source set may be used to answer all questions about the target configuration set. Again, machine learning module 238 may implement any of the approaches described with respect to machine learning module 213 above.

Referring now to FIG. 2B, a detailed overview 250 of the logical and/or physical components that may be included in and/or used by the processors (e.g., see 212, 217, etc., of FIG. 2A) and/or AI modules (e.g., see 213, 238, etc., of FIG. 2A) are illustrated in accordance with one approach, which is in no way intended to be limiting. As an option, the present overview 250 may be implemented in conjunction with features from any other approach listed herein, such as those described with reference to the other FIGS., such as FIG. 2A. However, such overview 250 and others presented herein may be used in various applications and/or in permutations which may or may not be specifically described in the illustrative approaches listed herein. Further, the overview 250 presented herein may be used in any desired environment. Thus FIG. 2B (and the other FIGS.) may be deemed to include any possible permutation.

As shown, the control plane 208 includes an API server 252 which connects storage to running operations (e.g., applications). Specifically, API server 252 is connected to resource storage 254, configuration storage 256, and timeseries storage 258. API server 252 is also connected to oplet 260 in running operation 262 as well as oplet 264 in running operation 266. In preferred approaches, control paths extend between API server 252 and oplets 260, 264. Configuration storage 256 and timeseries storage 258 are both connected to the discovery space 268 in oplet 260 and oplet 264. In preferred approaches, data paths extend between configuration storage 256 and timeseries storage 258; and the discovery spaces 268. A job controller 253 may also be used (e.g., in combination with the API server 252) to communicate with and/or between the storage 254, 256, 258 and running operations 262, 266.

In turn, oplet 260 in running operation 262 is connected to actuators 270 as well as a model 272 that has been trained to evaluate different possible configurations. Accordingly, the model 272 is able to inspect details in the discovery space 268. Similarly, oplet 264 is connected to model 272 such that details of discovery space 268 may be evaluated. For instance, the model 272 may include AI based models that have been trained to analyze a plurality of different system configurations that may be implemented in the discovery space 268 in a thorough and efficient manner. This may be accomplished in some approaches by using the model 272 to evaluate a source set of measured configurations, identify counterparts for this source set of representative configurations in an unmeasured target set, and comparing the performance values across both sets. In situations where the subsets are considered statistically similar, the source set may be used to answer all questions about the target configuration set. This desirably avoids the cost of benchmarking the entirety of the target set.

Looking now to FIG. 3A, a flowchart of a computer-implemented method 300 for predicting the performance metrics of a target set of unmeasured configurations using a source set of measured configurations. One or more of the operations in method 300 may thereby be used to determine a configuration for a specific application that meets predetermined performance objective(s) without experiencing performance shortcomings like conventional products. Again, method 300 utilizes the performance values from measured sets of configurations as a proxy for performance values for an unmeasured set of configurations. As noted above, a “configuration” includes a set of parameters and values that determine the behaviour and performance of a given implementation. Approaches herein thereby involve identifying a most desirable (e.g., “best”) configuration while also keeping search costs within reasonable bounds. This desirably avoids the cost of benchmarking the entirety of an unknown target set. Approaches herein thereby have a significant impact on efficiency of the system overall, e.g., as will be described in further detail below.

Each of the steps of the method 300 may be performed by any suitable component of the operating environment using known techniques and/or techniques that would become readily apparent to one skilled in the art upon reading the present disclosure. For example, one or more processors and/or AI modules in servers of a distributed system (e.g., see processor 212 and/or AI module 213 of FIG. 2A above) may be used to perform one or more of the operations in method 300.

Moreover, in various approaches, the method 300 may be partially or entirely performed by a controller, a processor, etc., or some other device having one or more processors therein. The processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

As shown, operation 302 includes dividing a search space associated with a source set of measured configurations into sub-spaces. In other words, operation 302 includes inspecting a number of measured (e.g., known) configurations that have been accumulated in a search space, and determining a number of different sub-spaces therein.

The sub-spaces themselves may be created differently depending on the approach. In some approaches, statistical information analysis may be used to divide the search space associated with the source set into the sub-spaces. For instance, existing data may be grouped into sub-spaces (e.g., groups) which are similar. Configuration combinations determined as producing similar (e.g., within a tolerance, in a predetermined range, above a threshold, etc.) performance metrics for the overarching system and/or application running therein may thereby be grouped together in a same or similar sub-space. The sub-spaces of measured configurations may thereby be traversed more efficiently to identify matches (e.g., overlaps) with components of unknown configurations.

The sub-spaces may be determined based on predetermined configuration settings, user preferences, past performance, identified patterns in the search space, etc. Moreover, the sub-spaces may be of any desired size. In some approaches each sub-space is about the same size, while in other approaches the sub-spaces are different sizes.

In some approaches, operation 302 is performed in response to receiving instructions to ingest given source sets of measured configurations. As noted above, approaches herein significantly improve the latency and compute overhead that is consumed while evaluating new, unmeasured configurations of a given system and/or application running thereon. This is achieved at least in part by extrapolating knowledge learned from measured configurations to these unmeasured configurations, e.g., as will be described in further detail below.

Method 300 advances from operation 302 to operation 304. There, operation 304 includes identifying representative configurations in at least some of the sub-spaces in the source set of measured configurations. In other words, operation 304 includes selecting a representative sample for each of the sub-spaces formed from the source set of measured configurations in operation 302. In some approaches, operation 304 includes applying one or more techniques to the source set of measured configurations, the one or more techniques being selected from the group consisting of: clustering, pattern matching, contributed information, and ranking. It follows that clustering, pattern matching, contributed information, ranking, and/or any other desired technique(s) may be applied to the source set of measured conditions in order to identify representative configurations therein.

From operation 304, method 300 advances to operation 306. There, operation 306 includes determining counterparts of the representative configurations in a target set of unmeasured configurations (also referred to herein as “translation”). In other words, operation 306 includes inspecting a target set of unmeasured configurations and identifying counterparts therein which correspond to the representative configurations in the sub-spaces of the source set created in operation 304. Operation 306 thereby effectively performs a translation which marries at least some of the unmeasured configurations in the target set with at least some of the measured configurations in the source set. The unmeasured configurations may be translated to a new domain (e.g., search space) for evaluation. This translation may be performed in some approaches by one or more trained AI based models performing pattern matching.

From operation 306, method 300 advances to operation 308. There, operation 308 includes evaluating performance metrics for the counterparts in the target set. In preferred approaches, one or more AI based models that have been trained to compare and inspect various performance metrics to gain an accurate understanding of how the system and/or application is performing given the configuration thereof, are used to perform operation 308. For instance, the process of evaluating performance metrics for the counterparts in the target set may include using AI based models that have been trained to adhere to a time and/or cost budget. In other words, the AI based models may be trained to evaluate the performance metrics of counterparts in the context of a limited temporal, monetary, resource-based, etc., cost and/or combinations thereof. The AI based models may thereby be able to recommend a particular configuration that is able to achieve a predetermined performance profile, e.g., as would be appreciated by one skilled in the art after reading the present description.

From operation 308, method 300 advances to operation 310. There, operation 310 includes assessing similarities between the source and target sets of application configurations. In other words, operation 310 includes determining whether any significant similarities exist between the measured source and unmeasured target sets of configurations. In some approaches, operation 310 involves using statistical techniques. For instance, operation 310 may involve using one or more AI based models that have been trained to incorporate statistical techniques. According to a non-limiting example, operation 308 may involve analyzing measurements of the representative samples based at least in part on pre-defined statistical tests (e.g., such as a delta per sample of less than X, the rank of results is the same, a relative distance is in a predetermined range, etc. and/or combinations thereof).

In response to the analysis performed in operations 308 and 310, method 300 advances to operation 312. There, a determination is made as to whether the measurements in the source set can be applied to the target set. In other words, operation 312 determines whether sufficient similarities exist between the measured source set of configurations and the unmeasured target set of configurations, such that an understanding of the source set may be applied to the target set, thereby avoiding a substantial amount of latency and compute overhead. The determination made in operation 312 may be performed by referencing a predetermined range, threshold, tolerance range(s), industry standards, etc. Moreover, operation 312 may involve adjusting what qualifies as a “sufficient similarity” between the measured and unmeasured configurations. For example, identified security threats may cause changes to be enacted that require a higher level of similarity between measured and unmeasured configurations before determining they may be correlated. In other examples, past performance may be evaluated by AI based models that have been trained to identify patterns that are indicative of changes between the configuration sets.

In response to determining that the measurements in the source set cannot be applied to the target set, method 300 advances from operation 312 to operation 314. There, operation 314 includes rejecting the source set. In other words, the source set of measured configurations is determined as not being sufficiently similar to the unmeasured target set of configurations, and therefore cannot be applied thereto. Rather, optional operation 316 includes creating new measurements for the target set. In other words, operation 316 includes optionally benchmarking the entirety of the unmeasured target set. It should be noted that in response to benchmarking the unmeasured target set in operation 316, approaches herein may re-initiate method 300. In other words, the unmeasured set of configurations effectively becomes a measured set in response to performing optional operation 316. Thus, the newly measured set of configurations may be divided into a number of sub-spaces in response to returning to operation 302 from operation 316. In other approaches, method 300 may end in response to performing operation 316.

However, returning to operation 312, method 300 advances to operation 318 in response to determining that the measurements in the source set can be applied to the target set. There, operation 318 includes causing the measurements in the source set to be applied to the target set. In other words, the source set is used to answer all questions about the target configuration set in response to determining that the source and target sets are sufficiently similar to do so. As noted above, applying known information to unmeasured sets of configurations significantly reduces latency and compute overhead that have plagued conventional implementations.

Referring momentarily now to FIG. 3B, exemplary steps of a process for causing the measurements in the source set to be applied to the target set is illustrated in accordance with one approach. It follows that one or more of these steps in process may be used to at least partially perform operation 318 of FIG. 3A above. Accordingly, these steps may be performed in the background while continuing to process sets of measured and unmeasured configurations. However, it should be noted that the steps in FIG. 3B are illustrated in accordance with one approach which is in no way intended to limit the invention.

As shown, step 350 includes training one or more AI based models on the measurements in the source set. The AI based models may be trained specifically on the information (e.g., measurements) that are included in the measured source set, thereby developing unobstructed insight into the various details of how the source set of configurations perform in a variety of situations. This may desirably allow the AI based models to accurately predict how various configurations that share some or all of the same configuration details as the source set.

From step 350, the flowchart proceeds to step 352. There, step 352 includes transferring the measurements in the source set to a new configuration space. Moreover, step 354 includes implementing the one or more trained AI based models in the new configuration space. Steps 352 and 354 thereby involve applying the known information about the source set and the trained AI based models in a space that allows for the target set to be fully processed using this known information. Accordingly, step 356 further includes applying the unmeasured target set of configurations in the new configuration space.

It follows that approaches herein are desirably able to efficiently learn to correct data for changed search spaces. This is achieved at least in part by implementing methods to partition existing data of a search space using statistical information analysis. The partition of existing data based on their respective characteristics is desirable, as the “representative samples” have a known meaning and are actually representative. Moreover, by implementing partitions (e.g., similarity, relative distance, contributed information, etc., and/or combinations thereof) taking into account, approaches herein solve the significant inefficiencies that conventional products have experienced, particularly at decision points. Again, approaches herein overcome these conventional shortcomings by solving problems by identifying and analyzing representative samples of known (e.g., measured) information. Moreover, by applying the approaches herein selectively, performance is further improved by reducing latency.

In addition to workload configuration searches, approaches herein may also be applied to hyper-parameter searches of AI based (e.g., machine learning) models and/or searches for fine-tuning the metrics, algorithms, hyperparameters, etc., of AI based models (e.g., foundation models). Approaches herein are also workload and/or domain agnostic. The approaches herein may thereby be applied in cloud configurations, Large Language Models (LLMs) inference and/or training, big data analytics, etc., and/or combinations thereof.

Approaches herein may also be applied to a number of different implementations. For example, one or more of the approaches herein may be applied to a service which takes an informed space and an uninformed space, returning predictions about the uninformed space along with information on why these predictions were made. In this case, statistical testing of such a service would reveal the usage approaches herein, as the statistical behavior of approaches herein differs significantly to conventional implementations, e.g., as would be appreciated by one skilled in the art after reading the present description.

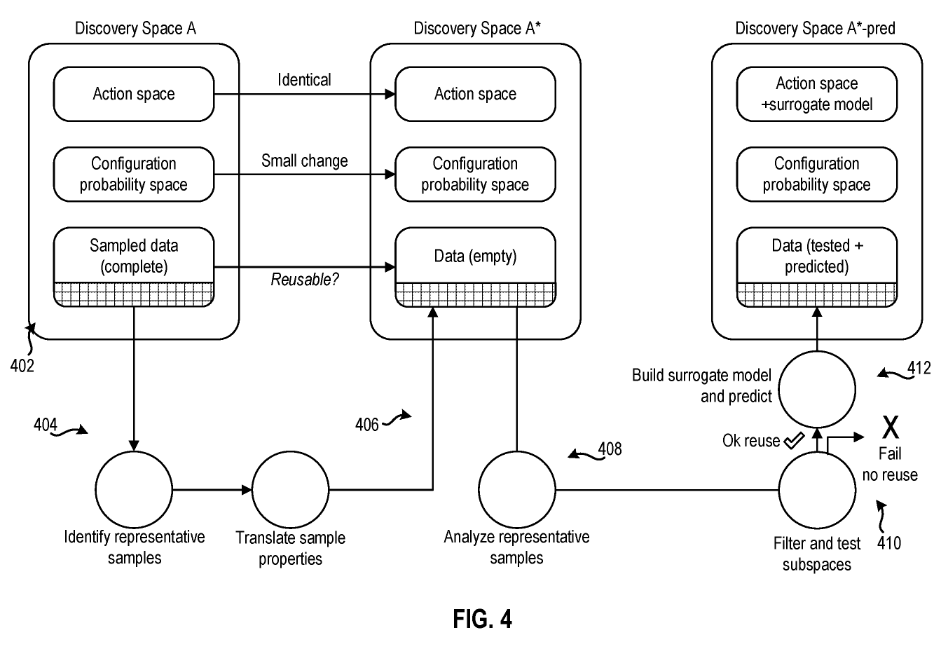

Referring now to FIG. 4, an in-use example of how a measured source set of configurations may be compared against a set of unmeasured configurations. As shown, a source set of measured configurations are present in a first Discovery Space A, while a target set of unmeasured configurations are present in a second Discovery Space A*.

The process of defining the source and target spaces and comparing them is illustrated in operation 402. There, operation 402 involves determining whether the Action Space in each of the Discovery Spaces are an identical match (e.g., are sufficiently similar to each other). Here, the discovery space includes space that is formed by enumerating all possible configurations with the value ranges of specified configuration parameters. Moreover, the action space includes space of possible actions for gathering metrics for the configurations, where the metrics are used to inform about the quality (e.g., suitability) of the different configurations. In response to determining that the action space of both discovery spaces are identical, the Configuration Probability Spaces are compared. In response to determining that the configuration space parameters are identical, it may be determined that the difference in the two Discovery Spaces is implicit. Moreover, in response to determining that the configuration space parameters have a bijective mapping therebetween, the mapping will likely explicitly identify how the Discovery Spaces differ.

Advancing to operation 404, representative sub-space identification is performed. In other words, operation 404 includes clustering the samples in Discovery Space A according to one or more properties of the Action Space. The clustering also preferably includes choosing centroid as a representative sample. Proceeding to operation 406, there selected representative samples are translated into new configuration space.

Moreover, operation 408 includes measuring and analyzing the translated samples. The method to use for comparison may be problem dependent. According to two non-limiting examples, comparison of absolute values and comparison of rankings (e.g., ranking configurations on throughput) may be performed.

Operation 410 further includes performing a known transfer. For instance, all samples belonging to clusters are identified as transferrable in operation 410. Typically, all clusters will be identified as transferrable unless outlier clusters are excluded, e.g., as would be appreciated by one skilled in the art after reading the present description. Moreover, operation 412 includes modifying A* to A*-pred by adding a “predictor” version of the pred original experiment, and translating the source values using the identified linear relationship.

Again, approaches herein are desirably able to takes in a known and an unknown space of parameter values for a specific problem and returns a prediction on how the unknown space behaves along statistical guarantees for these predictions. The predictions are made based on clustering the known space to find representative parameter samples, translating them to the unknown space, and evaluating them. It follows that the selection of representative sub-spaces (e.g., clusters) may be performed with different methods of pattern matching, contributed information, ranking of the known space, etc., and/or combinations thereof. The samples are also preferably generated to be the most representative of the parameter space, and their number may even be bounded by a sampling (e.g., temporal and/or monetary) budget. The predictions may thereby be made based at least in part on a few representative measurements that have been validated by statistical tests including delta per sample, ranking, relative distance, etc., and/or combinations thereof.

It will be clear that the various features of the foregoing systems and/or methodologies may be combined in any way, creating a plurality of combinations from the descriptions presented above.

It will be further appreciated that approaches of the present invention may be provided in the form of a service deployed on behalf of a customer to offer service on demand.

The descriptions of the various approaches of the present invention have been presented for purposes of illustration, but are not intended to be exhaustive or limited to the approaches disclosed. Many modifications and variations will be apparent to those of ordinary skill in the art without departing from the scope and spirit of the described approaches. The terminology used herein was chosen to best explain the principles of the approaches, the practical application or technical improvement over technologies found in the marketplace, or to enable others of ordinary skill in the art to understand the approaches disclosed herein.

What is claimed is:

1. A method comprising:
identifying representative configurations in a source set of measured configurations;
determining counterparts of the representative configurations in a target set of unmeasured configurations;
evaluating performance metrics for the counterparts in the target set;
assessing similarities between the source and target sets; and
determining whether the measurements in the source set can be applied to the target set.

2. The method of claim 1, wherein the identifying representative configurations in the source set of measured configurations includes:
applying one or more techniques to the source set, wherein the one or more techniques are selected from the group consisting of: clustering, pattern matching, contributed information, and ranking.

3. The method of claim 1, wherein the evaluating performance metrics for the counterparts in the target set includes:
using AI based models that have been trained to adhere to a time and/or cost budget.

4. The method of claim 1, wherein the assessing similarities between the source and target sets includes using one or more AI based models that have been trained to incorporate statistical techniques.

5. The method of claim 1, further comprising:
in response to determining that the similarities between the source and target sets are in a predetermined range, causing the measurements in the source set to be applied to the target set.

6. The method of claim 5, wherein the causing the measurements in the source set to be applied to the target set includes:
training one or more AI based models on the measurements in the source set;
transferring the measurements in the source set to a new configuration space; and
implementing the one or more trained AI based models in the new configuration space.

7. The method of claim 1, further comprising:
in response to determining that the similarities between the source and target sets are not in a predetermined range, rejecting the source set.

8. The method of claim 1, wherein the identifying representative configurations in the source set of measured configurations includes:
dividing a search space associated with the source set into sub-spaces; and
identifying representative configurations in at least some of the sub-spaces.

9. The method of claim 8, further comprising:
using statistical information analysis to divide the search space associated with the source set into the sub-spaces.

10. A computer program product comprising:
one or more computer-readable storage media; and
program instructions stored on the one or more storage media to perform operations comprising:
identifying representative configurations in a source set of measured configurations;
determining counterparts of the representative configurations in a target set of unmeasured configurations;
evaluating performance metrics for the counterparts in the target set;
assessing similarities between the source and target sets; and
determining whether the measurements in the source set can be applied to the target set.

11. The computer program product of claim 10, wherein the identifying representative configurations in the source set of measured configurations includes:
applying one or more techniques to the source set, wherein the one or more techniques are selected from the group consisting of: clustering, pattern matching, contributed information, and ranking.

12. The computer program product of claim 10, wherein the evaluating performance metrics for the counterparts in the target set includes:
using AI based models that have been trained to adhere to a time and/or cost budget.

13. The computer program product of claim 10, wherein the assessing similarities between the source and target sets includes using one or more AI based models that have been trained to incorporate statistical techniques.

14. The computer program product of claim 10, wherein the operations further comprise:
in response to determining that the similarities between the source and target sets are in a predetermined range, causing the measurements in the source set to be applied to the target set.

15. The computer program product of claim 14, wherein the causing the measurements in the source set to be applied to the target set includes:
training one or more AI based models on the measurements in the source set;
transferring the measurements in the source set to a new configuration space; and
implementing the one or more trained AI based models in the new configuration space.

16. The computer program product of claim 10, wherein the operations further comprise:
in response to determining that the similarities between the source and target sets are not in a predetermined range, rejecting the source set.

17. The computer program product of claim 10, wherein the identifying representative configurations in the source set of measured configurations includes:
dividing a search space associated with the source set into sub-spaces; and
identifying representative configurations in at least some of the sub-spaces.

18. A computer system comprising:
a processor set;
one or more computer-readable storage media; and
program instructions stored on the one or more storage media to cause the processor set to perform operations comprising:
identifying representative configurations in a source set of measured configurations;
determining counterparts of the representative configurations in a target set of unmeasured configurations;
evaluating performance metrics for the counterparts in the target set;
assessing similarities between the source and target sets; and
determining whether the measurements in the source set can be applied to the target set.

19. The computer system of claim 18, wherein the identifying representative configurations in the source set of measured configurations includes:
applying one or more techniques to the source set, wherein the one or more techniques are selected from the group consisting of: clustering, pattern matching, contributed information, and ranking.

20. The computer system of claim 18, wherein the evaluating performance metrics for the counterparts in the target set includes:
using AI based models that have been trained to adhere to a time and/or cost budget.
